(19) United States
(12) Patent Application Publication
(10) Pub. No.: US 2008/0181987 A1
(43) Pub. Date: Jul. 31, 2008

(54) MEAT SEASONING PRODUCT AND METHOD

(76) Inventors: Joey W. Lusby, Omaha, NE (US); Gary W. Uram, Omaha, NE (US); Gordon Lee Smith, Omaha, NE (US); Erik I. Hassid, Omaha, NE (US); Jennifer Weil, Papillion, NE (US); Shawn M. Peters, Omaha, NE (US); Jeffrey B. Schneider, Benton City, WA (US)

Correspondence Address: Merchant & Gould - ConAgra, P.O. Box 2903, Minneapolis, MN, 55402, US

(21) Appl. No.: 12/021,948

(22) Filed: Jan. 29, 2008

Related U.S. Application Data
(60) Provisional application No. 60/898,344, filed on Jan. 29, 2007.

(51) Int. Cl. A23L 1/314; A23B 4/03; A22C 5/00; A22C 7/00

(52) U.S. Cl. 426/62; 426/92; 426/641; 426/302; 99/494; 99/349

(57) ABSTRACT

A method for seasoning meat comprising providing at least a portion of a processed meat, applying a first adhesive layer on a surface of the at least a portion of the processed meat, and adhering a first seasoning blend to the at least a portion of the processed meat by utilizing the first adhesive layer.

### CROSS REFERENCE TO RELATED APPLICATIONS

This application claims priority from U.S. Provisional Patent Application Ser. No. 60/898,344, filed Jan. 29, 2007 and is hereby incorporated by reference in its entirety.

### TECHNICAL FIELD

This disclosure relates generally to seasoned meat products and methods for seasoning meat products.

### BACKGROUND

Meat snacks, such as jerky (also known as charqui), fall into two general categories: those made from sliced, whole meat and those formulated from comminuted meat. Meat products produced using sliced, whole meat are considered a premium product because of the texture which results. Such products may be produced by marinating large portions of meat in a composition which may comprise ingredients such as water, liquid smoke, brown sugar, proprietary seasoning, salt and sodium nitrate and/or sodium erythorbate curing agents. The marinated meat may then be permitted to cure for a period of time before it is sliced into pieces or strips. The sliced portions are then smoked, dried, and/or cured to produce the finished product.

Alternatively, jerky may be formed from comminuted meat. The meat is first broken into smaller particles by grinding, flaking, or other common methods then blended along with additional dry ingredients and any required water. The resulting mass is then passed through a sheeter or extruded to be formed into strips or tubes, or into a stuffer to be put into casings. Finally, the pieces are smoked, dried, and/or cured as in traditional production methods. Comminuted jerky and meat-based snack sticks are made through similar processes. The main distinctions are the shape into which each is formed and the final moisture level to which each is dried.

Current meat product production processes commonly incorporate flavoring and seasoning as processing steps prior to the drying/smoking process. Additionally, in order to further expedite the commercial production of meat products, the drying operations are often enhanced using heating and drying devices. However, this accelerated heating/drying can have adverse effects on the visual and/or flavor characteristics of the seasoning particulates. Specifically, a product having a desired seasoning may also have a corresponding consumer-recognized color associated therewith. For example, a consumer may expect a Cajun flavored meat product to have red or orange particulates associated with cumin or red pepper seasonings. Should such seasonings be applied prior to the heating/drying step, the red or orange colored particulates may become dulled and less appetizing due to the extended exposure to elevated temperatures and airflows found in current heating/drying processes.

### SUMMARY

Accordingly, the present disclosure is directed to a seasoned meat product, a method for producing a seasoned meat product, and a system for a seasoning a processed meat product.

An aspect of the present disclosure relates to the seasoned meat product comprising at least a portion of a processed meat, a first adhesive layer coating the at least a portion of the processed meat, the first adhesive layer being an applied coating, and a seasoning blend disposed on the first adhesive layer.

An aspect of the present disclosure relates to the method for seasoning meat comprising providing at least a portion of a processed meat, applying a first adhesive layer on a surface of the at least a portion of the processed meat, and adhering a first seasoning blend to the at least a portion of the processed meat by utilizing the first adhesive layer.

An aspect of the present disclosure relates to the system for seasoning a processed meat product comprising means for applying an adhesive layer on a surface of at least a portion of a processed meat and means for disposing a seasoning blend on the surfaced of the at least a portion of the processed meat.

An aspect of the present disclosure relates to the method for seasoning meat comprising providing at least a portion of jerky, disposing a first adhesive layer on a surface of the at least a portion of the jerky, and adhering a seasoning blend to the at least a portion of the jerky by utilizing the first adhesive layer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DRAWINGS

The numerous objects and advantages of the present disclosure may be better understood by those skilled in the art by reference to the accompanying figures in which:

FIG. 1 depicts a block diagram for a method having exemplary features of aspects in accordance with the principles of the present disclosure;

FIG. 2 depicts a system for seasoning processed meat product having exemplary features of aspects in accordance with the principles of the present disclosure;

FIGS. 3a, 3b, and 3c depict cross-sectional views of seasoned meat products having exemplary features of aspects in accordance with the principles of the present disclosure; and

FIG. 4 depicts partial isometric views of seasoned meat products having exemplary features of aspects in accordance with the principles of the present disclosure.

### DETAILED DESCRIPTION

Reference will now be made in detail to the exemplary aspects of the present disclosure that are illustrated in the accompanying drawings. Wherever possible, the same reference numbers will be used throughout the drawings to refer to the same or like structure.

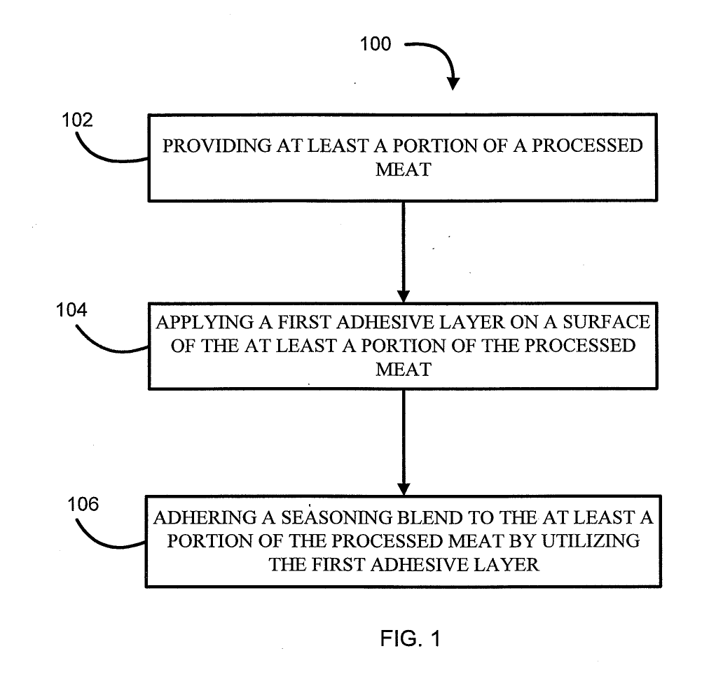

Referring to FIG. 1, a process flow diagram detailing a method for producing a seasoned meat product 100 having exemplary features of aspects in accordance with the principles of the present disclosure is shown. A processed meat product may be provided, 102. It will also be appreciated by those skilled in the art that various other food substrates, including but not limited to fruits, vegetables, and starches, may be utilized in the inventive process without departing from the spirit of the disclosure. In particular, popcorn and seeds, such as popcorn, pumpkin and sunflower seeds, may be utilized. Meats used to make the processed meat products may include beef, chicken, pork, turkey, wild game, venison, elk, salmon and tuna, among others. The processed meat product is a jerky-type product or a product which is precooked via radiant heating devices, microwave heating devices, oven heating devices, or by frying. This list is not meant to be restrictive. It is appreciated that any type of precooking suitable for increasing meat preservation may be utilized to form the processed meat product without departing from the scope and intent of the disclosure. A jerky-type processed meat product may be formed by marinating striate meat portions in a curing solution, slicing the marinated meat portions and then drying the sliced meat product in an environment having elevated temperatures and/or airflows for an extended period of time. The curing solution may be substantially free of seasoning particulates that are not typically found in a brine mix as the flavor, color and texture imparted to the meat product by these particulates may be degraded during the drying step of the preparation process.

Alternatively, a processed meat product may be formed by comminuting meat portions and incorporating the comminuted meat portions into an emulsion. The emulsion may further comprise curing agents, water and extenders (e.g. processed soy products). The emulsion may then be extruded into individual meat products comprising strips, tubes, or chunks by methods common to the art. The meat products may then be dried by disposing them in an environment having elevated temperatures and/or airflows for an extended period of time.

An adhesive composition and/or layer may be applied to the processed meat product, 104. The term “applied” or “application” as utilized herein refers to the physical placement of a first composition onto a second separate composition and/or product. The term “applied coating” as utilized herein refers to the application of an adhesive layer to the processed meat product, wherein the adhesive layer is composition separated from the processed meat product. The adhesive compositions may comprise (by weight): (a) water—from about 44% to about 58% inclusive; (b) sugar—from about 36% to about 50%; inclusive and corn syrup solids—from about 6% to about 8% inclusive. More specifically, the adhesive composition may comprise (by weight): (a) water—about 50%; (b) sugar—about 43%; and corn syrup solids—about 7%. The adhesive composition may comprise gelatins (i.e., 20 bloom and/or Knnox™), gums, and/or encapsulated oil infused with yeast. The adhesive composition and/or layer may comprise a gum such as alginate. The adhesive composition may further comprise a combination of water, corn syrup solids, sugar, gelatins, gums, and/or encapsulated oil infused with yeast. This list is not restrictive. It is understood that the adhesive composition may comprise any suitable meat adhesive composition for preventing a seasoning from substantially falling off of a processed meat product. The adhesive composition and/or layer may be applied to the processed meat product by any number of methods common to the art including atomized spraying, dipping, brushing, laminating, or continuous flow wash. This list is not restrictive. It is appreciated that any suitable application for applying the adhesive composition to the processed meat product may be utilized without departing from the scope and intent of the disclosure. The processed meat product may have a composition pick-up (by processed meat product weight) of from about 2% to about 10% inclusive. More specifically, the composition pick-up (by processed meat product weight) may be from about 4% to about 8% inclusive.

The adhesive composition and/or layer may be a separate component that is not found inherently in the meat product. The adhesive composition and/or a portion of the adhesive composition may be a composition found inherently in the meat that has been separated from the meat and reapplied to the processed meat product. Further, the adhesive layer may not comprise grease produced from the heating of the processed meat product. However, the adhesive composition and/or a portion of the adhesive composition may comprise grease produced from the processing of the meat product that was separated from the meat product and then reapplied to the meat product after processing.

The adhesive layer may be heated before being applied to the processed meat product. The adhesive layer may be heated from about 50° F. to about 200° F. inclusive. The adhesive layer may be heated from about 50° F. to about 60° F. inclusive. The adhesive layer may be heated from about 60° F. to about 70° F. inclusive. The adhesive layer may be heated from about 70° F. to about 80° F. inclusive. The adhesive layer may be heated from about 80° F. to about 90° F. inclusive. The adhesive layer may be heated from about 90° F. to about 100° F. inclusive. The adhesive layer may be heated from about 100° F. to about 110° F. inclusive. The adhesive layer may be heated from about 110° F. to about 130° F. inclusive. The adhesive layer may be heated from about 130° F. to about 150° F. inclusive. The adhesive layer may be heated from about 150° F. to about 180° F. inclusive. The adhesive layer may be heated from about 180° F. to about 200° F. inclusive.

The adhesive coated processed meat product may be heated by a heating device so as to partially congeal the adhesive composition, thereby creating a more favorable surface on which to apply a seasoning blend. The heating and dwell times are considerably shorter and less intense than the time required from cooking, drying or smoking a meat product during processing. As such, this heating step is not sufficient for the processing and/or precooking methods utilized to form the processed meat product.

A seasoning blend may be adhered to at least a portion of processed meat by utilizing the adhesive composition, 106. The seasoning blend may comprise (by weight): (a) a flavoring component—from about 20% to about 100% inclusive; and/or (b) a cracked or crushed whole grain component—from about 0% to about 80% inclusive. The flavoring component may be selected from one or more of those common to the art including: black pepper, mesquite, garlic, jalapeño, taco, salsa, chili, fajita, teriyaki, Cajun, Caribbean, Italian, brown sugar, cinnamon sugar, sweet and sour, maple, honey garlic, nacho, honey mustard, barbeque, cheese, chive and onion, sour cream and onion, horseradish, and ranch, among others. This list is not restrictive. It is appreciated that any suitable flavoring component for a processed meat product may be utilized without departing from the scope and intent of the disclosure.

The grain component may be selected from one or more of those common in the art including: wheat barley, corn, oats, quinoa, rye and rice. This list is not restrictive. It is understood that other suitable whole grain products may be utilized with the disclosure. These substantially flavor-neutral grain components may serve to provide additional visual and corporal texture to the meat product, as is desired from premium meat products, without necessitating the inclusion of excessive amounts of the flavoring component as would be required to achieve a similar texture profile.

The seasoning blend may be further secured to the meat product by pressing mechanism.

The seasoning blend, having been disposed about the process meat product, may be further integrated into the processed meat product by a pressing mechanism, thereby increasing the adhesion of the seasoning blend to the meat product. The pressing mechanism may be conventional food press or a rolling-bar mechanism. This list is not restrictive. It is appreciated that processing mechanism may be any suitable processing mechanism for pressing the seasoning composition onto the processed meat product without departing from the scope and intent of the disclosure.

The seasoning blend may be incorporated or integrated into the adhesive composition mixture prior to its application to the meat product. The term “integrated” or “integrating” as utilized herein refers to the mixing of two different compositions to form a single mixture or composition, such as the mixing of the adhesive composition with the seasoning blend to form a single mixture or composition. In such a scenario, the seasoning blend and adhesive composition may be applied to the meat product simultaneously so as to further secure the seasoning blend to the meat product, thereby rendering coating and pressing unnecessary.

The flavoring component and whole grain component may be applied to the processed meat product at distinct times. The flavoring component may be applied as previously described where the processed meat product is coated with the flavoring component either independently or as a component of the adhesive composition. The whole grain component may then be applied to the processed meat product following application of the adhesive composition.

An additional coating of adhesive composition (i.e., a second adhesive layer) may be applied to further secure the seasoning blend components to the processed meat product. The additional adhesive layer may coat the portion of the processed meat product coated by the first adhesive layer. The additional adhesive layer may coat the portion of the processed meat product that is at least partially free of the first adhesive layer. A second seasoning blend may be disposed on the second adhesive layer. The additional adhesive composition may include any number of preservative compositions which are know to extend the self like of the seasoned meat products, including but not limited to, mold inhibitors. The additional coating of an adhesive composition (or a second adhesive layer) may comprise a combination of water, corn syrup solids, sugar, gelatins, gums, and/or encapsulated oil infused with yeast. It is understood that the second adhesive layer may comprise any suitable meat adhesive composition for preventing a seasoning from substantially falling off of a processed meat product and/or for preserving the processed meat product.

The adhesive composition may be heat-set. The heat-setting may be accomplished by disposing a seasoned meat product within an impingement over for a period of time sufficient to dehydrate the adhesive composition layer such that it forms a congealed matrix thereby affixing the seasoning blend to the meat product. The heat-setting may occur at a temperature of from about 350° F. to about 400° F. inclusive with a dwell time of from about 2 minutes to about 4 minutes inclusive. The heat-setting may occur at a temperature of about 380° F. with a dwell time of about 3 minutes. Such dwell times are considerably shorter that the time required from cooking, drying or smoking a meat product. As such, the seasonings will undergo much less thermal degradation than in conventional processing and/or precooking methods utilized to form the processed meat product.

The level of dehydration of the adhesive composition may be such that the final moisture content of the seasoned meat product is substantially similar to that of the processed meat product. The moisture content values are established such that microbial growth may be inhibited. A seasoned meat product may have a moisture-to-protein ratio of from about 0.5:1 to about 2.5:1 inclusive.

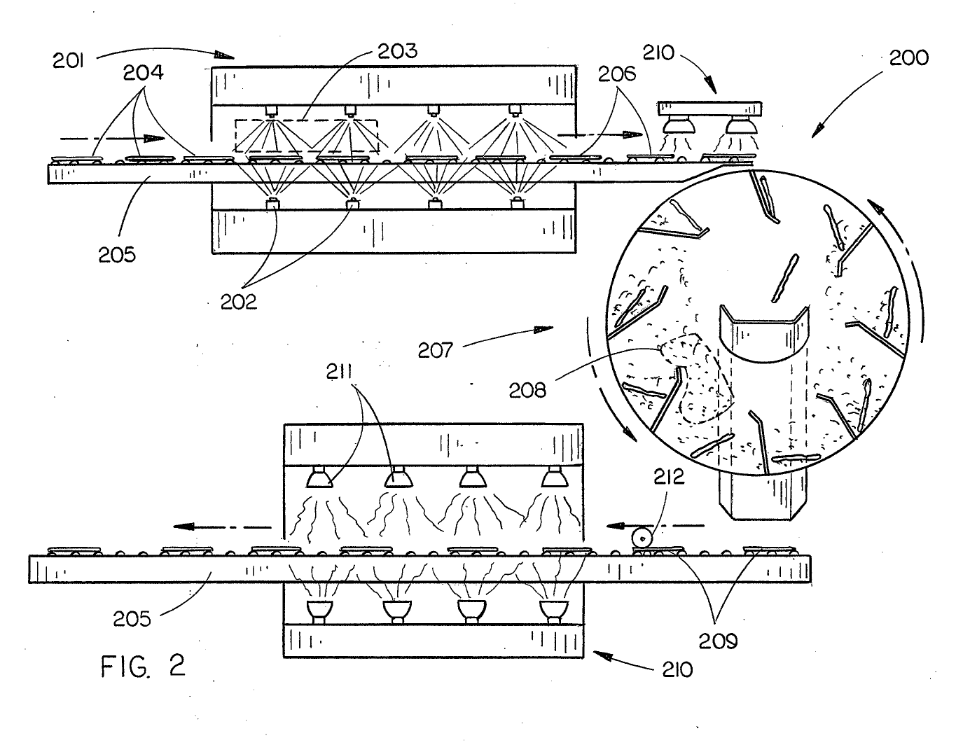

Referring to FIG. 2, a processing system 200 for seasoning a processed meat product having exemplary features of aspects in accordance with the principles of the present disclosure is shown. The system may include an adhesive composition application mechanism 201. The adhesive composition application mechanism may comprise a plurality of atomizing spray nozzles 202. Representative adhesive composition application mechanisms known in the art included those produced by General Oil Equipment™ located at 60 John Glenn Drive, Amherst, N.Y. 14228. An adhesive composition 203 may be applied to meat products 204 via the spray nozzle 202 as the meat products 204 continue along a conveyor 205.

The adhesive composition coated meat products 206 may be heated by a heating device (not shown), such as an impingement oven, so as to partially congeal the adhesive composition, thereby creating a more favorable surface on which to apply a seasoning blend. The disclosure is not limited to an impingement oven. It is appreciated that any suitable heating device may be utilized for partially congealing the adhesive composition without departing from the scope and intent of the disclosure.

Following the application of the adhesive composition 203, the adhesive composition coated processed meat products 206 may be transferred to a seasoning application device 207. The seasoning application device 207 may be selected from those common to the art, including tumblers, traditional bed/waterfall breading or seasoning applicators, and the like. This list is not restrictive. It is understood that any suitable seasoning application device for a processed meat product may be utilized without departing from the scope and intent of the disclosure. The adhesive composition coated meat products 206 are coated with a seasoning blend 208, thereby providing for the adhesion of the seasoning blend 208 of to the adhesive composition coated meat product 206.

The seasoning blend 208 may be incorporated into the adhesive composition mixture 203 prior to the composition's application to the meat product 204. In such a scenario, the seasoning blend 208 and adhesive composition 203 may be applied to the meat product 204 simultaneously so as to further secure the seasoning blend to the meat product and rendering the seasoning application device unnecessary.

A seasoning integration mechanism 213 may be incorporated whereby the seasoning blend 208 may be further integrated into the adhesive composition coated meat product 203 by an exertion of force, thereby further securing the seasoning blend 208 to the processed meat product 206. The integration mechanism may be selected from any of those known in the art, including but not limited to a rolling-bar mechanism 213 or a conventional mechanical food press (not shown). This list is not restrictive. It is appreciated that the integration may be any suitable mechanism for incorporating the seasoning blend into the adhesive layer coating the processed meat product without departing from the scope and intent of the disclosure. The integration mechanism may comprise a high-pressure processing apparatus which applies ambient pressure to the seasoned product so as to further direct the seasoning blend 208 into the adhesive composition coated meat product 206.

Following the application of the seasoning blend 208 via the adhesive composition 203, the seasoned meat products 209 may be passed through a heat-setting device 210. The heat-setting device may comprise an impingement oven having radiant heating elements 211 and blowers (not shown). The seasoned meat products may be maintained within the heat-setting device for a period of time sufficient to dehydrate the adhesive composition layer of the seasoned meat product 209 such that it forms a congealed matrix thereby affixing the seasoning blend 208 to the processed meat product. The heat-setting device may be any suitable heat setting device that does not substantially dehydrate the processed meat product while producing enough heat to substantially set the adhesive composition.

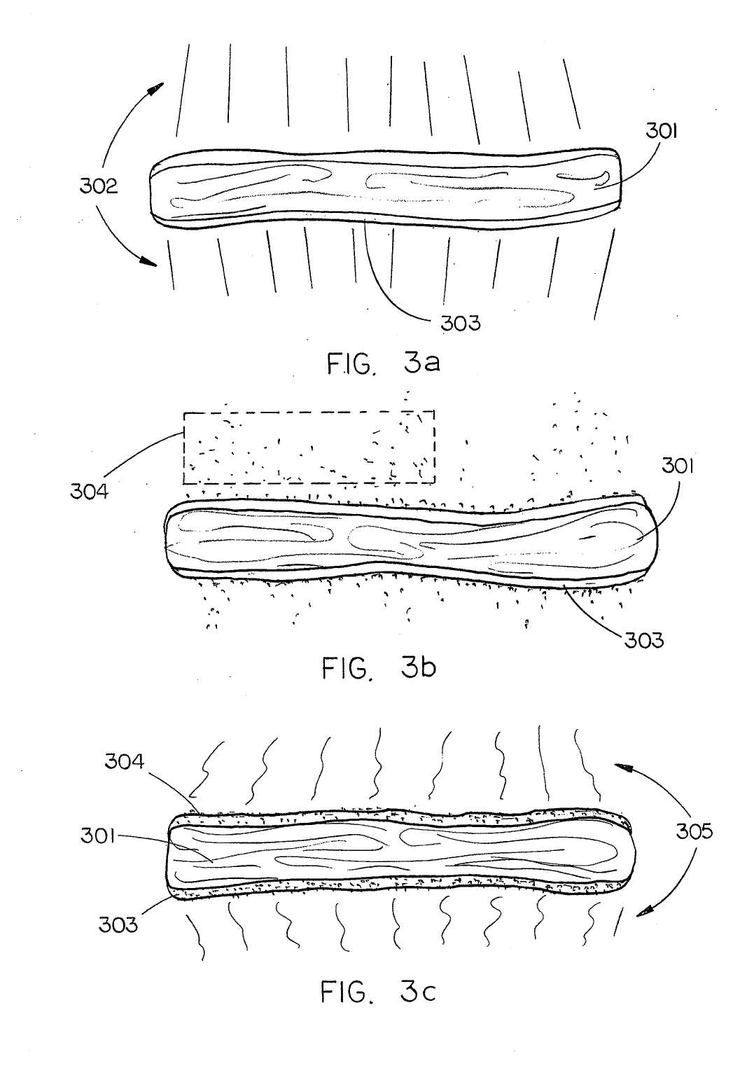

Referring to FIGS. 3a, 3b, and 3c, cross-sectional views of meat products having exemplary features of aspects in accordance with the principles of the present disclosure are shown. Referring to FIG. 3a, a portion of processed meat 301 undergoing adhesive composition 302 application is shown. During application, the processed meat 301 may become coated with an adhesive composition layer 303. Referring to FIG. 3b, a portion of processed meat 301 having an adhesive composition layer 303 applied substantially about is shown. A seasoning blend 304 may be impregnated within the adhesive composition layer 303. Referring to FIG. 3c, a portion of seasoned is shown. The seasoned meat may comprise an adhesive composition lay 303 which secures a seasoning blend 304 to at least a portion of processed meat 301. The seasoned meat may be subjected to radiant heating and drying, thereby causing the adhesive composition layer 303 to congeal and further secure the seasoning blend 304 to the processed meat 301.

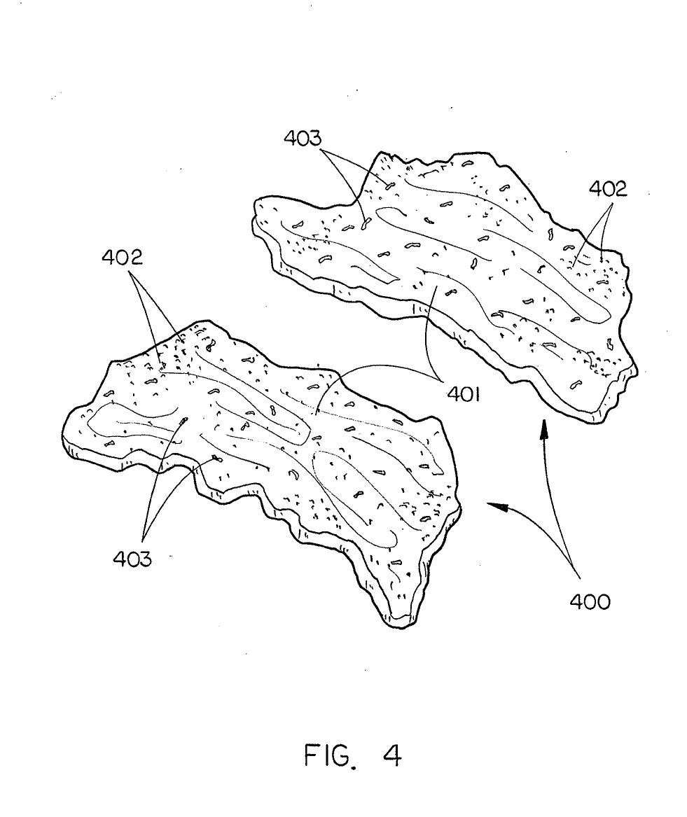

Referring to FIG. 4, partial isometric views of seasoned meat products 400 having exemplary features of aspects in accordance with the principles of the present disclosure is shown. The seasoned meat products may comprise portions or striate meat 400 which have been processed from a raw form into a dried, jerky-type product. These processed meat portions 400 may be coated with an adhesive composition layer 401 which serves to bond flavoring 402 and/or whole-grain 403 components to the meat 400.

The seasoned meat product produced by this process provides for a seasoned, processed meat product that may utilized different spices than conventionally flavored processed meat products because the seasoning are not subjected to the harsh temperatures of the meat processing steps, such as utilized in brine processing. Further, the seasonings may retain their consumer-recognized color because the seasoning is not subjected to the harsh temperatures of the meat processing steps. The seasoned meat product of this disclosure reduces the amount of seasoning fall off or the amount of seasoning that falls off of the processed meat product prior to consumption without incorporating the seasoning into the processing step (i.e., brine processing and/or smoking) of meat product. Therefore, the seasoned meat product may utilize more flavor with consumer-recognized color without substantial seasoning fall off.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A seasoned meat product, the seasoned meat product comprising:
at least a portion of a processed meat;
a first adhesive layer coating the at least a portion of the processed meat, the first adhesive layer being an applied coating; and
a seasoning blend disposed on the first adhesive layer.

2. The seasoned meat product of claim 1, wherein the processed meat is jerky.

3. The seasoned meat product of claim 1, wherein the processed meat is selected from a group comprising:
beef; chicken; pork; turkey; wild game; venison; elk; salmon; and tuna.

4. The seasoned meat product of claim 1, wherein the adhesive layer comprises:
water;
sugar; and
corn syrup solids.

5. The seasoned meat product of claim 4, wherein the adhesive layer further comprises at least one of gelatin, gums, or yeast infused with oil.

6. The seasoned meat product of claim 4, wherein the adhesive layer further comprises:
the water present in an amount of from about 44% to about 58% inclusive by weight of the adhesive layer;
the sugar present in an amount from about 36% to about 50% inclusive by weight of the adhesive layer; and
the corn syrup solids present in an amount from about 6% to about 8% inclusive by weight of the adhesive layer.

7. The seasoned meat product of claim 4, wherein the adhesive layer further comprises:
the water present in an amount of about 50% by weight of the adhesive layer;
the sugar present in an amount of about 43% by weight of the adhesive layer; and
the corn syrup solids present in an amount of about 7% by weight of the adhesive layer.

8. The seasoned meat product of claim 1, wherein the adhesive layer is at least one of a gum, a gelatin, or a yeast infused in with oil composition.

9. The seasoned meat product of claim 1, wherein the seasoning blend comprises:
one or more flavoring components selected from a group comprising black pepper; salt; mesquite; garlic; jalapeño; taco; salsa; chili; fajita; teriyaki; Cajun; Caribbean; Italian; brown sugar; cinnamon sugar; sweet and sour; maple; honey garlic; nacho; honey mustard; barbeque; cheese; chive and onion; sour cream and onion; horseradish; and ranch.

10. The seasoned meat product of claim 9, wherein the seasoning blend further comprises a whole grain component.

11. The seasoned meat product of claim 10, wherein the seasoning blend further comprises:
the one or more flavoring components in amount from about 20% to about 100% inclusive by weight of the seasoning blend, and
the whole grain component present in an amount from about 0% to about 80% inclusive by weight of the seasoning blend.

12. The seasoned meat product of claim 1, further comprising a second adhesive layer coating the first adhesive layer or coating the at least a portion of the processed meat that is at least partially free of the seasoning blend or the first adhesive layer.

13. A method for seasoning meat, the method comprising steps of:
providing at least a portion of a processed meat;
applying a first adhesive layer on a surface of the at least a portion of the processed meat; and
adhering a first seasoning blend to the at least a portion of the processed meat by utilizing the first adhesive layer.

14. The method of claim 13, further comprising a step of heating the first adhesive layer and the processed meat.

15. The method of claim 13, further comprising heating the first adhesive layer prior to applying the first adhesive layer to the surface of the at least a portion of the processed meat.

16. The method of claim 13, wherein the step of adhering a first seasoning blend to the at least a portion of the processed meat by utilizing the first adhesive layer comprises integrating the first seasoning blend into the first adhesive layer before performing the step of applying the first adhesive layer on the surface of the at least a portion of the processed meat for simultaneous application of the first adhesive layer and the first seasoning blend.

17. The method of claim 13, wherein the step of adhering the first seasoning blend to the at least a portion of the processed meat by utilizing the first adhesive layer comprises applying the first seasoning blend to the at least a portion of the processed meat after the step of applying the first adhesive layer on the surface of the at least a portion of the processed meat for separate application of the first adhesive layer and the first seasoning blend.

18. The method of claim 13, further comprising a step of heating the processed meat, the first adhesive layer, and the first seasoning blend.

19. The method of claim 18, wherein the heating step further comprises dehydrating the processed meat, the first adhesive layer, and the first seasoning blend until the processed meat, the first adhesive layer, and the first seasoning blend have a combined moisture-to-protein ratio of from about 0.5:1 to about 2.5:1 inclusive, by weight.

20. The method of claim 18, wherein the heating step further comprises heating the processed meat, the first adhesive layer, and the first seasoning blend in an environment with a temperature of from about 350° F. to about 400° F. inclusive for a dwell time of from about 2 minutes to about 4 minutes inclusive.

21. The method of claim 13, further comprising a step of applying a second adhesive layer on the surface of the at least a portion of the processed meat and the first adhesive layer.

22. The method of claim 21, further comprising a step of heating the processed meat, the first adhesive layer, the first seasoning blend and the second adhesive layer.

23. The method of claim 13, further comprising a step of applying a second adhesive layer on a second surface of at least a portion of the processed meat at least partially free of the first adhesive layer.

24. The method of claim 23, further comprising adhering a second seasoning blend to the second surface of at least a portion of the processed meat at least partially free of a first adhesive layer by utilizing the second adhesive layer.

25. A system for seasoning a processed meat product, the system comprising:
means for applying an adhesive layer on a surface of at least a portion of a processed meat; and
means for disposing a seasoning blend on the surface of the at least a portion of the processed meat.

26. The system of claim 25, further comprising a means for pressing the seasoning blend into the adhesive layer.

27. The system of claim 25, further comprising a means for heating the adhesive layer and seasoning blend.

28. A method for seasoning meat, the method comprising steps of:
providing at least a portion of jerky;
disposing a first adhesive layer on a surface of the at least a portion of the jerky; and
adhering a seasoning blend to the at least a portion of the jerky by utilizing the first adhesive layer.

29. The method of claim 28, wherein the step of disposing the first adhesive layer on the surface of the at least a portion of the jerky is an applied coating on the at least a portion of the jerky.

30. The method of claim 28, further comprising heating the at least a portion of the jerky, the first adhesive layer, and the seasoning blend to heat-set the first adhesive layer without sufficient temperature and dwell time to process and/or precook the processed meat.

31. The method of claim 30, wherein the heating step utilizes a temperature of from about 350° F. to about 400° F. inclusive for a duration of from about 2 minutes to about 4 minutes inclusive.

32. The method of claim 28, further comprising applying a second adhesive layer to the surface of the at least a portion of the jerky and the adhered seasoning blend.

33. The method of claim 32, wherein the second adhesive layer comprises a preservative.

34. The method of claim 28, further comprising a step of applying a second adhesive layer on a second surface of at least a portion of the jerky at least partially free of the first adhesive layer.

35. The method of claim 28, wherein the adhesive layer comprises about 50% water, about 43% sugar, and about 7% corn syrup solid by weight.

36. The method of claim 28, wherein the step of adhering the seasoning blend to the at least a portion of the jerky by utilizing the first adhesive layer comprises integrating the seasoning blend into the first adhesive layer before performing the step of applying the first adhesive layer on the surface of the at least a portion of the jerky for simultaneous application of the first adhesive layer.

37. The method of claim 28, wherein the step of adhering the seasoning blend to the at least a portion of the jerky by utilizing the first adhesive layer comprises adhering the seasoning blend to the at least a portion of the jerky after the step of applying the first adhesive layer on the surface of the at least a portion of the jerky for separate application of the first adhesive layer and the seasoning blend.
